(19) United States
(12) Patent Application Publication
(10) Pub. No.: US 2006/0294262 A1
(43) Pub. Date: Dec. 28, 2006

(54) Portable VOIP wireless connector

(75) Inventor: Tung Ju Su, Jhonghe City (TW)

Correspondence Address: TROXELL LAW OFFICE PLLC, SUITE 1404, 5205 LEESBURG PIKE, FALLS CHURCH, VA, 22041, US

(73) Assignee: Airus Technology Co., Ltd.

(21) Appl. No.: 11/158,072

(22) Filed: Jun. 22, 2005

(51) Int. Cl. G06F 3/00

(52) U.S. Cl. 710/13

(57) ABSTRACT

A portable VOIP wireless connector comprising: a USB connecting interface used as an interface for connecting a computer; a multimedia chip for controlling sound effect to transmit to a wireless module; a USB controller to control the ROM and the flash memory; the wireless module used to convert a sound effect into radio frequency signals for transmitting; the flash memory to store variable data; and the ROM to store invariable data (such as VOIP software). The wireless connector is inserted into a USB connecting port of the computer, the computer automatically executes the VOIP software in the ROM and inputs related parameters for setting up, and sends radio frequency signals via the wireless module to the wireless devices, so that a user can proceed to voice conversation, and can save the cumbersome software activating procedure and can be free of tangling by wires.

### BACKGROUND OF THE INVENTION

1. Field of the Invention

The present invention is related to a portable VOIP wireless connector, and especially to a connector to make a kind of VOIP software and its related parameters be built in the connector, in order that the connector can fast activate the function of VOIP when the connector is connected with a computer, and that a user can proceed to voice conversation, and can store the applied software of VOIP and the information of persons being contacted.

2. Description of the Prior Art

Modern families mostly have more than one computer each, by popularization of INTERNET, and by competition among ISP's to render nonstop lowering to charges for networking, amount of persons networking via ADSL grows proportionally; thereby, it has been being a medium for remote communication for modern people to use INTERNET for communications and contacts (such as e-mails, remote video conferences, voice conversations and instant word transmissions etc.) to gradually take the place of conventional ways of correspondences or communications via telephones.

Among the ways of network communications, voice Over IP (or shortly, VOIP) is a popular mode, and it derives software or programs such as Skype, MSN etc. in the markets used for network voice conversations, these software or programs require that two computers at two terminals are installed with a kind of VOIP software for easily proceeding to dialog by voice conversation between two sides via network transmissions using names of persons, ID's or numbers as media. While the abovementioned VOIP has the superiority of being free of communication charges and high quality of communication, it only needs word receiving and sending devices (such as speakers, microphones) for conversation, and can make communication by installing related software; it is welcome by individuals, companies or enterprises, and many related products have been gradually derived.

However, software for VOIP can only be use by installing on a computer, after the software for VOIP is activated, communication can only be done by inputting names of persons, ID's or numbers for login; and conversation can be done through the word receiving and sending devices (such as speakers, microphones) and by installing the related software; hence the function of conventional VOIP can only be developed after the steps of installing, activating, login and setting etc. are performed.

Moreover, all kinds of software for general VOIP are installed on specific computers, and those computers for installing the VOIP software mostly are in houses or companies, if there is no available computer outdoors, two sides are unable to use VOIP to make voice conversation; and when in doing business outside or being going abroad, a person must reinstall and set up again even if he has a computer; these are extremely inconvenient, computers in airports or Internet Cafes are all public, and are unable for installing or setting up software by a user, most public computers are provided with speakers for outputting sounds, but they have no microphone for the user to use the function of VOIP.

Further, the word receiving and sending devices (such as speakers, microphones) used for network VOIP are all equipments with cables under the consideration of cost, they often make tangling of the cables or wires in use, microphones need close distance sound receiving in using and are not portable, they always are complained of these, thus they still have evident defects necessary to be improved in practical using.

### SUMMARY OF THE INVENTION

Therefore, the primary object of the present invention is to provide a portable VOIP wireless connector able to directly connect with a computer to execute VOIP software, to proceed to voice conversation and to reduce the procedure and time for executing the software.

The secondary object of the present invention is to provide a portable VOIP wireless connector able to emit radio frequency signals through a wireless module, and to transmit the signals to wireless devices (a wireless earphone, a microphone etc.), in order that there is no tangling by cables or wires during the voice conversation.

Another object of the present invention is to provide a portable VOIP wireless connector which, by providing a read only memory (ROM) and a flash memory, stores VOIP software and its related parameters (VOIP ID, Username) to direct login when in execution of the VOIP software, in order to make more convenient for voice conversation.

To get the above objects, the present invention comprises mainly:

a USB connecting interface used as an interface for connecting a computer;

a multimedia chip connected between the USB connecting interface and a wireless module for controlling sound effect for transmitting to the wireless module;

a USB controller connected with the USB connecting interface to control the read only memory (ROM) and the flash memory;

the wireless module used to convert for a sound effect card of a multimedia chip to get radio frequency signals for transmitting;

the flash memory connected with the multimedia chip and the USB controller, to store variable data (such as VOIP ID, Username or basic setting up parameters);

the read only memory (ROM) connected with the multimedia chip and the USB controller to store invariable data (such as VOIP software).

When in use, the USB connecting interface is inserted into a USB connecting port of the computer, the computer recognizes and confirms the multimedia chip and the USB controller to automatically execute the VOIP software in the read only memory (ROM) and to set up the related parameters of the computer (the VOIP ID, Username), and sends radio frequency signals via the wireless module to the wireless devices (the wireless earphone, the microphone etc.), so that a user can proceed to voice conversation through the VOIP easily, and can save the cumbersome software activating procedure and can be free of tangling by wires, thereby he can enjoy the convenience of the wireless VOIP.

The present invention will be apparent in its particular structure, using and features after reading the detailed description of the preferred embodiment thereof in reference to the accompanying drawings.

### BRIEF DESCRIPTION OF THE DRAWINGS

FIG. 1 is a schematic view of the present invention;

FIG. 2 is a flow chart for the present invention;

FIG. 3 is a schematic view showing use of the present invention;

FIG. 4 is a flow chart for receiving words of the present invention;

FIG. 5 is a flow chart for sending words of the present invention.

### DETAILED DESCRIPTION OF THE PREFERRED EMBODIMENT

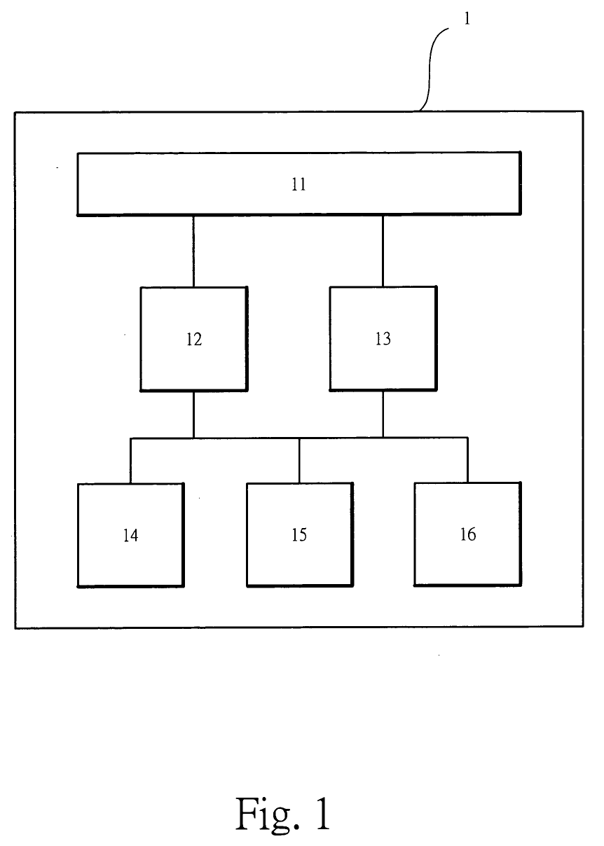

Referring firstly to FIG. 1, the portable VOIP wireless connector of the present invention mainly comprises:

a USB connecting interface 11 used as an interface for connecting a computer 2;

a multimedia chip 12 connected between the USB connecting interface 11 and a wireless module 14 for controlling sound effect for transmitting to the wireless module 14;

a USB controller 13 connected with the USB connecting interface 11 to control a read only memory (ROM) 16 and a flash memory 15;

the wireless module 14 used to convert for a sound effect card of a multimedia chip 12 to get radio frequency signals for transmitting;

the flash memory 15 connected with the multimedia chip 12 and the USB controller 13, to store variable data;

the read only memory (ROM) 16 connected with the multimedia chip 12 and the USB controller 13 to store invariable data.

Wherein: the transmission protocol of the wireless module 14 is Bluetooth, Wireless Lan or RF (radio frequency) etc.

The read only memory (ROM) 16 shall store a kind of VOIP software (Skype, MSN etc.) before use.

The flash memory 15 shall store and login the basic data of the VOIP software (such as VOIP ID, Username or basic setting up parameters) before use.

In the preferred embodiment of the present invention, for example, the transmission protocol of the wireless module 14 is Bluetooth.

When in use, the USB connecting interface 11 is inserted into a USB connecting port (not shown) of the computer 2, the computer 2 recognizes and confirms the multimedia chip 12 and the USB controller 13 to automatically execute the VOIP software in the read only memory (ROM) 16 and to set up the related parameters of the computer 2 (the VOIP ID, Username), and sends radio frequency signals via the wireless module 14 to the wireless devices (the wireless earphone, the microphone etc.), so that the user can proceed to voice conversation through the VOIP easily.

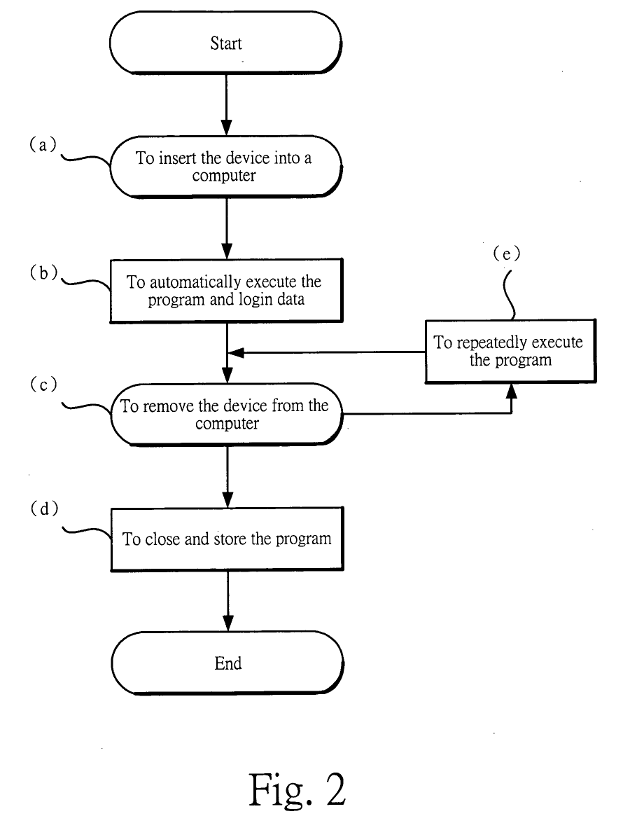

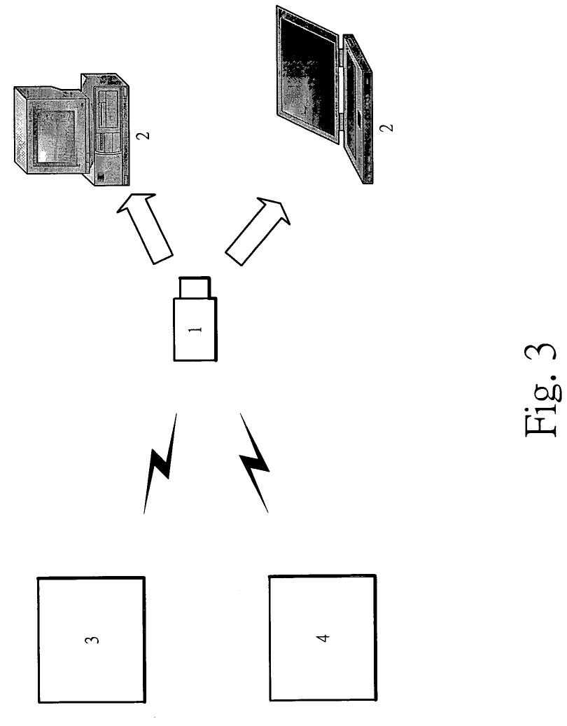

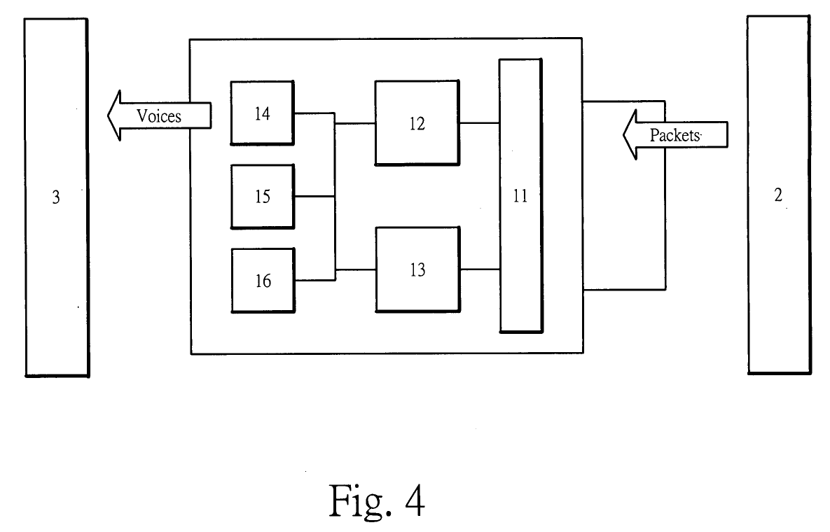

Referring to FIGS. 2, 3 and 4, when the USB connecting interface 11 is inserted into a USB connecting port (not shown) of the computer 2, the computer 2 recognizes and confirms the multimedia chip 12 and the USB controller 13, and the operation system (such as Windows) of the computer 2 will activate the standard Media Driver, the Storage Driver and the CDROM Driver (Hidden); and the computer 2 will automatically execute the VOIP software in the read only memory (ROM) 16 and to activate the VOIP program, meantime it picks up the data in the flash memory 15 (such as the VOIP ID, Username or basic setting up parameters) to login to the VOIP program, the related parameters of the computer 2 and the settings of the devices; when the user receives words, he transmits digital packets to the multimedia chip 12 and converts into voices through the multimedia chip 12, and sends the voices through the wireless module 14 to a word receiving device 3 (wireless speakers and the wireless earphone), in order that the user can proceed to voice conversation; and more, when the user sends words using the VOIP, he sends the voices to the wireless module 14 through a word sending device 4 to convert them into digital packets by the multimedia chip 12, and to transmit to the computer 2 through the USB connecting interface 11, and then sends to a user at the other terminal through INTERNET.

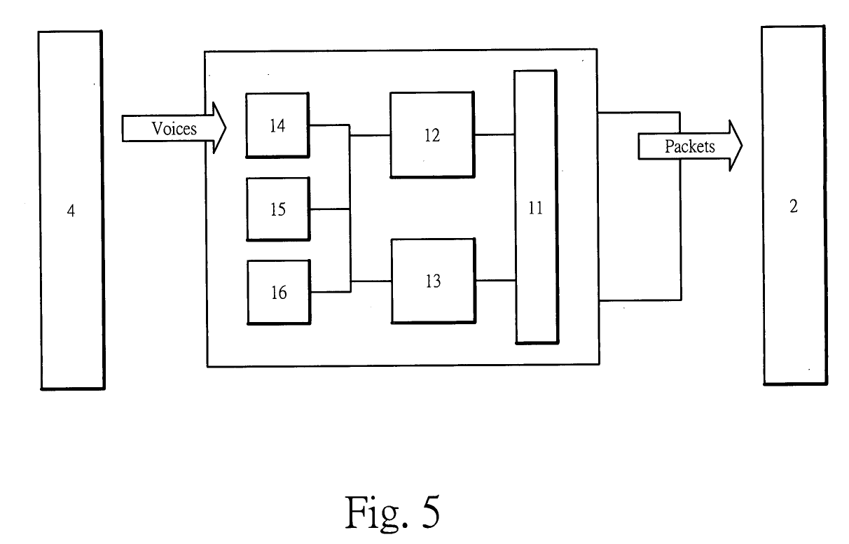

Referring to FIG. 5, the steps for executing the above wireless connector 1 are as below:
(a) to insert the device into a computer: after the USB connecting interface 11 is inserted into the computer 2, the computer 2 recognizes and confirms the multimedia chip 12 and the USB controller 13, and the operation system (such as Windows) of the computer 2 will activate the standard Media Driver, the Storage Driver and the CDROM Driver.
(b) to automatically execute programs and login data: the computer 2 will automatically execute the VOIP software in the read only memory (ROM) 16 and to activate the VOIP program, meantime it picks up the data in the flash memory 15 (such as the VOIP ID, Username or basic setting up parameters) to login to the VOIP program, the related parameters of the computer 2 and the settings of the devices; so that the user can proceed to voice conversation. If the device is inserted into the computer 2 and keeps on connecting with the computer 2, the following step (e) is executed.
(c) to remove the device from the computer: when the device is removed from the computer 2, the following step (d) is executed.
(d) to close and store the program: when the computer 2 detects removing of the device, all executing actions are stopped to close the VOIP software and make record, also the radio frequency signals of the wireless module 14 are interrupted.
(e) to repeatedly execute the program: the VOIP software is repeatedly executed.

The present invention thus has the following advantages:
1. A user can use the VOIP without installing any software or program.
2. By storing the information of the user of the VOIP into the flash memory 15 (such as the VOIP ID, Username or basic setting up parameters), no more login is required when the VOIP program is reactivated.
3. The present invention uses a word receiving device 3 and a word sending device 4 (a wireless speaker, a wireless earphone and a wireless microphone) to proceed to voice conversation, in order that there is no tangling by cables or wires.
4. The present invention has the functions of plug and play as well as auto run; it is convenient and time saving without influencing on the stability of the computer 2.

With the portable VOIP wireless connector of the present invention, it solves the problem that the function of the VOIP can only be used when the computer 2 is activated; a user needs only to carry with him the wireless connector when in doing business outside or being going abroad. Even if he is in an airport, a Internet Cafe or somebody's company, just by inserting the wireless connector 1 into a USB connecting port of the computer 2, the VOIP can be used through networking without the necessity of reinstalling any software or driving program, nor the necessity of second time login or setting up; and only needs to carry the portable VOIP wireless connector 1, the word receiving device 3 and the word sending device 4 (a wireless speaker, a wireless earphone and a wireless microphone) to proceed to doing communication through the VOIP anywhere. The convenience required for portability is realized; and even the computer 2 has no speakers or microphone, it still can use the VOIP application; and the cumbersome software activating procedure can be saved, and the phenomenon of tangling by wires can be gotten rid of, thereby the convenience of the wireless VOIP can be increased.

The above stated are only for illustrating the preferred embodiment of the present invention, and not for giving any limitation to the scope of the present invention. It will be apparent that various equivalent modifications or changes made to the elements of the present invention without departing from the spirit of this invention shall fall within the protective scope of the appended claims.

1. A portable VOIP wireless connector comprising:
a USB connecting interface used as an interface for connecting a computer;
a multimedia chip connected between said USB connecting interface and a wireless module for controlling sound effect for transmitting to said wireless module;
a USB controller connected with said USB connecting interface to control a read only memory (ROM) and a flash memory;
said wireless module used to convert for a sound effect card of a multimedia chip to get radio frequency signals for transmitting;
said flash memory connected with said multimedia chip and said USB controller, to store invariable data;
said read only memory (ROM) connected with said multimedia chip and said USB controller to store invariable data.

2. The portable VOIP wireless connector as stated in claim 1, wherein said read only memory (ROM) stores a kind of VOIP software before use.

3. The portable VOIP wireless connector as stated in claim 1, wherein said flash memory stores and logins basic data of a kind of VOIP software before use.

4. The portable VOIP wireless connector as stated in claim 1, wherein the transmission protocol of said wireless module is Bluetooth.

5. The portable VOIP wireless connector as stated in claim 1, wherein the transmission protocol of said wireless module is Wireless Lan.

6. The portable VOIP wireless connector as stated in claim 1, wherein the transmission protocol of said wireless module is RF (radio frequency).
